(19) United States
(12) Patent Application Publication
(10) Pub. No.: US 2025/0392709 A1
(43) Pub. Date: Dec. 25, 2025

(54) REFERENCE AREA FOR INTRA PREDICTION

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US)

(21) Appl. No.: 18/879,038

(22) PCT Filed: May 3, 2023
(86) PCT No.: PCT/EP2023/061654

§ 371 Date: Dec. 26, 2024

Related U.S. Application Data
(60) Provisional application No. 63/356,293, filed on Jun. 28, 2022.

(51) Int. Cl. H04N 19/117; H04N 19/159; H04N 19/167; H04N 19/176; H04N 19/82

(52) U.S. Cl. CPC H04N 19/117; H04N 19/159; H04N 19/167; H04N 19/176; H04N 19/82

(57) ABSTRACT

An apparatus may be configured to: select a coding unit of an image; select a first area within a coded area of the image, wherein the first area comprises, at least, a first part and a second part, wherein the first part is at least partially different from the second part; perform in-loop filtering of, at least, the first part of the first area; perform intra prediction for the selected coding unit based, at least partially, on the first area, comprising the in-loop filtered first part; and output an intra-prediction block for the selected coding unit based on the performed intra prediction.

### TECHNICAL FIELD

The example and non-limiting embodiments relate generally to encoding and decoding and, more particularly, to intra prediction.

### BACKGROUND

It is known, in an encoder, to perform intra prediction based on a reconstructed block.

### SUMMARY

The following summary is merely intended to be illustrative. The summary is not intended to limit the scope of the claims.

In accordance with one aspect, an apparatus comprising: at least one processor; and at least one memory including computer program code; the at least one memory and the computer program code configured to, with the at least one processor, cause the apparatus at least to: select a coding unit of an image; select a first area within a coded area of the image, wherein the first area comprises, at least, a first part and a second part, wherein the first part is at least partially different from the second part; perform in-loop filtering of, at least, the first part of the first area; perform intra prediction for the selected coding unit based, at least partially, on the first area, comprising the in-loop filtered first part; and output an intra-prediction block for the selected coding unit based on the performed intra prediction.

In accordance with one aspect, a method comprising: selecting a coding unit of an image; selecting a first area within a coded area of the image, wherein the first area comprises, at least, a first part and a second part, wherein the first part is at least partially different from the second part; performing in-loop filtering of, at least, a first part of the first area; performing intra prediction for the selected coding unit based, at least partially, on the first area, comprising the in-loop filtered first part; and outputting an intra-prediction block for the selected coding unit based on the performed intra prediction.

In accordance with one aspect, an apparatus comprising means for performing: selecting a coding unit of the image; selecting a first area within a coded area of the image, wherein the first area comprises, at least, a first part and a second part, wherein the first part is at least partially different from the second part; in-loop filtering of, at least, the first part of the first area; intra prediction for the selected coding unit based, at least partially, on the first area, comprising the in-loop filtered first part; and outputting an intra-prediction block for the selected coding unit based on the performed intra prediction.

In accordance with one aspect, a non-transitory computer-readable medium comprising program instructions stored thereon which, when executed with at least one processor, cause the at least one processor to: select a coding unit of the image; select a first area within a coded area of the image, wherein the first area comprises, at least, a first part and a second part, wherein the first part is at least partially different from the second part; perform in-loop filtering of, at least, the first part of the first area; perform intra prediction for the selected coding unit based, at least partially, on the first area, comprising the in-loop filtered first part; and cause output of an intra-prediction block for the selected coding unit based on the performed intra prediction.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10 is a diagram illustrating features as described herein; and

FIG. 11 is a flowchart illustrating steps as described herein.

### DETAILED DESCRIPTION OF EMBODIMENTS

The following abbreviations that may be found in the specification and/or the drawing figures are defined as follows:
3GPP third generation partnership project
4G fourth generation
5G fifth generation
5GC 5G core network
ABC-ALF alternative band classifier for adaptive loop filter
ALF adaptive loop filter
AR augmented reality
BIF bilateral filter
CABAC context-adaptive binary arithmetic coding
CCALF cross-component adaptive loop filter
CCSAO cross-component sample adaptive offset
CDMA code division multiple access
CPU central processing unit
CTU coding tree unit
CU coding unit
ECM enhanced compression model
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDMA frequency division multiple access
gNB (or gNodeB) base station for 5G/NR, i.e., a node providing NR user plane and control plane protocol terminations towards the UE, and connected via the NG interface to the 5GC
GPU graphical processing unit
GSM global systems for mobile communications
HMD head-mounted display
IBC intra block copy
IEEE Institute of Electrical and Electronics Engineers
IMD integrated messaging device
IMS instant messaging service
Intra TMP Intra Template Matching Prediction
IoT Internet of Things
JVET Joint Video Experts Team
LTE long term evolution
MMS multimedia messaging service
MPEG-I Moving Picture Experts Group immersive codec family
MR mixed reality
ng or NG new generation
ng-eNB or NG-eNB new generation eNB
NR new radio
PC personal computer
PDA personal digital assistant
SAO sample adaptive offset
SMS short messaging service
TCP-IP transmission control protocol-internet protocol
TDMA time division multiple access
UE user equipment (e.g., a wireless, typically mobile device)
UMTS universal mobile telecommunications system
USB universal serial bus
VR virtual reality
VVC versatile video coding
WLAN wireless local area network

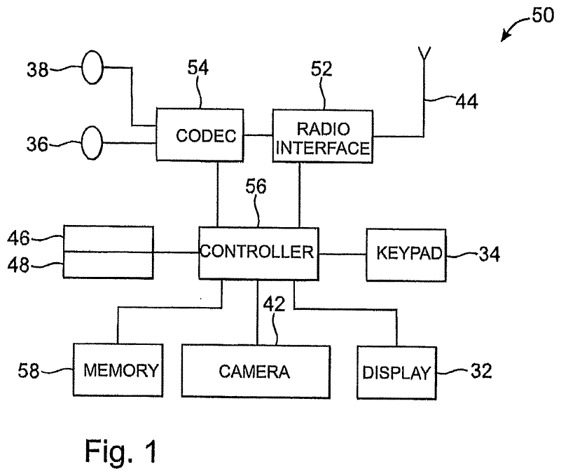

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-I) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that embodiments of the invention may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in embodiments of the invention may be any one of: an earpiece, speaker, or an analogue audio or digital audio output connection. The electronic device 50 may also comprise a battery (or in other embodiments of the invention the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other embodiments the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device 50 may further comprise an input device 34, such as a keypad, one or more input buttons, or a touch screen input device, for providing information to the controller 56.

The electronic device 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise a camera 42 or other sensor capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

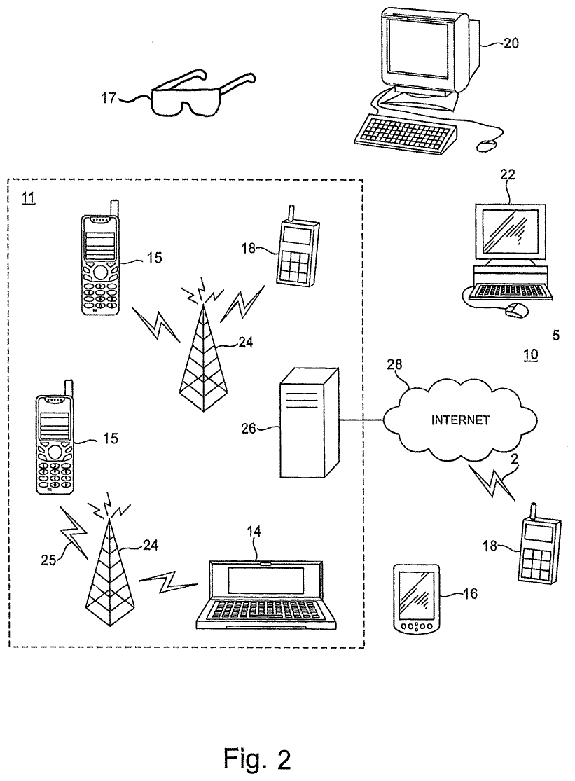

With respect to FIG. 2, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G network etc.), a wireless local area network (WLAN) such as defined by any of the IEEE 802.x standards, a BLUETOOTH™ personal area network, an Ethernet local area network, a token ring local area network, a wide area network, and/or the Internet.

The system 10 may include both wired and wireless communication devices and/or electronic devices suitable for implementing embodiments of the invention.

For example, the system shown in FIG. 2 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The embodiments may also be implemented in cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTH™, IEEE 802.11, 3GPP Narrowband IoT and any similar wireless communication technology. A communications device involved in implementing various embodiments of the present invention may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Having thus introduced a suitable but non-limiting technical context for the practice of the example embodiments of the present disclosure, example embodiments will now be described with greater specificity.

Features described herein generally relate to processing of image sequences, or videos. In versatile video coding (VVC) (see, e.g., B. Bross, J. Chen, S. Liu, Y-K Wang, “Versatile Video Coding”, JVET-02001-VE, June 2020) and enhanced compression model (ECM) (see, e. g., https://vcgit.hhi. fraunhofer.de/ecm/ECM/-/tree/ECM-5.0), a video sequence comprises a plurality of pictures. Each picture may be divided into coding tree units (CTUs). A CTU may be further split, for example using a quadtree with nested multi-type tree structure, into a plurality of coding units (CUs). For each CU, an encoder may search an (intra or inter) prediction block, which may be constructed from the reconstructed pixels in the coded area of the current picture, or from the reconstructed pixels in the past coded pictures. The encoder may subtract the (intra or inter) prediction block from the CU. The resulting residual block may then be transformed, and the transformed coefficients may be quantized. The quantized transformed coefficients may be context-adaptive binary arithmetic coding (CABAC) coded into a compressed bitstream.

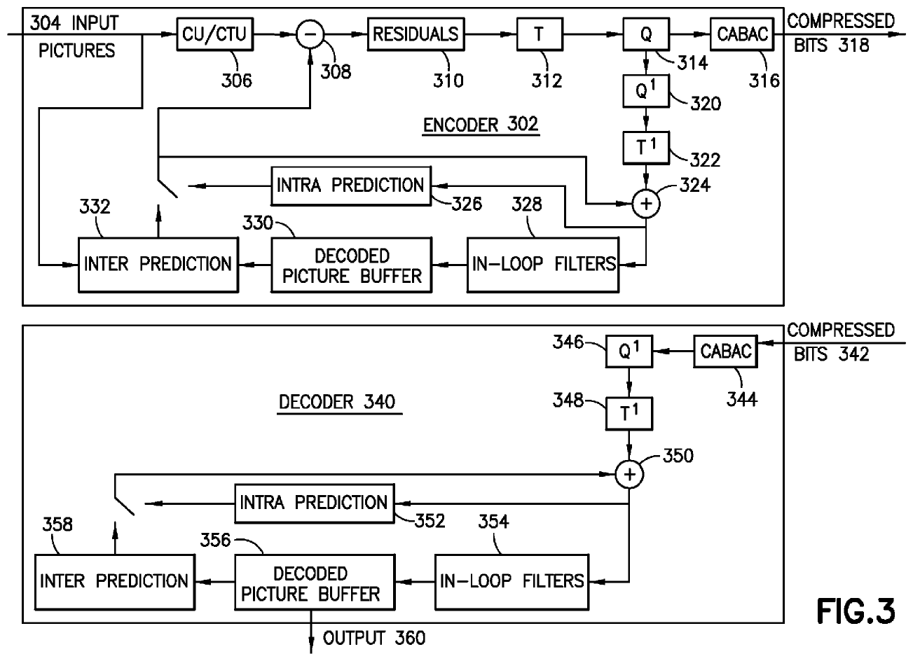

FIG. 3 illustrates diagrams of an example encoder (302) and an example decoder (340). In the encoder (302), input pictures (304) may be divided into a CU or CTU (306), a prediction block may be subtracted (308) to form a residual (310), which may be transformed (312) and quantized (314) before coding (316) as compressed bits (318) into a bitstream. The quantized transformed coefficients may also be dequantized/inverse quantized (320) and inverse transformed (322), and combined with the output of a prediction block (324). The result may then be used in intra prediction (326) and may be (e.g. in parallel) in-loop filtered (328), included in a decoded picture buffer (330), and used in inter prediction (332). In the decoder (340), compressed bits (342) may be decoded (344), dequantized (346), inverse transformed (348), and combined with the output of a prediction block (350). The result may then be used in intra prediction (352) and may be (e.g. in parallel) in-looped filtered (354), included in a decoded picture buffer (356), and used in inter prediction (358). The contents of the decoded picture buffer (356) may be output (360).

As shown in FIG. 3, the decoder (340) may actually be part of the coding loop of the encoder (302) in a reverse way (e.g. 320-332). The quantized transformed coefficients in the encoder (e.g. after quantization block (314), or the output of CABAC (344) in the decoder) may be dequantized (320, 346) and inverse transformed (322, 348), generating the coded residual block (e.g. 324, 350). The (intra or inter) prediction block (326, 332, 352, 358) may then be added to the coded residual block (324, 350), generating the reconstructed block. In-loop filtering may be performed over the reconstructed block (328, 354), forming the final reconstructed block. The final reconstructed blocks may be stored in a decoded picture buffer (330, 356) for output (360), as well as for possible use of future coding.

In VVC and ECM, inter prediction uses the past coded pictures as reference pictures. The reference pictures may comprise the final reconstructed pixels after in-loop filtering, which may have the technical effect of providing more accurate prediction. In contrast, intra prediction uses the coded area of the current picture before in-loop filtering as the reference area. The reference area comprises the non-final reconstructed pixels before in-loop filtering, which may have the technical effect of providing less accurate prediction.

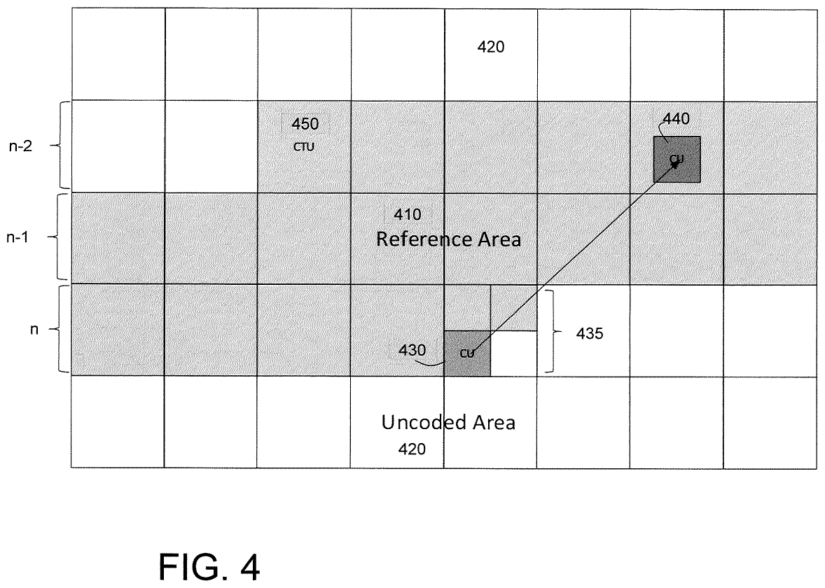

One of the coding tools supported in VCC and ECM is intra block copy (IBC). For a current CU, IBC searches for a prediction block in a reference area of the current picture. The reference area is the coded area of the current picture before in-loop filtering. Accordingly, the reference area comprises the non-final reconstructed pixels, which may mean less accurate prediction. FIG. 4 shows the reference area (green, 410) for a current CU (blue, 430), where the big blocks are CTUS. ECM has increased the reference area for IBC significantly, as compared to VVC. The reference area (green, 410) now covers many coded CUs/CTUs, including all the coded CUs in the current CTU (435), all the coded CTUs in the current CTU row (n), all the coded CTUS in the above CTU row (n−1), and some or all of the coded CTUs in CTU row (n−2). A block/CU (red, 440) inside the reference area (green, 410) may be the prediction block for the current CU (blue, 430).

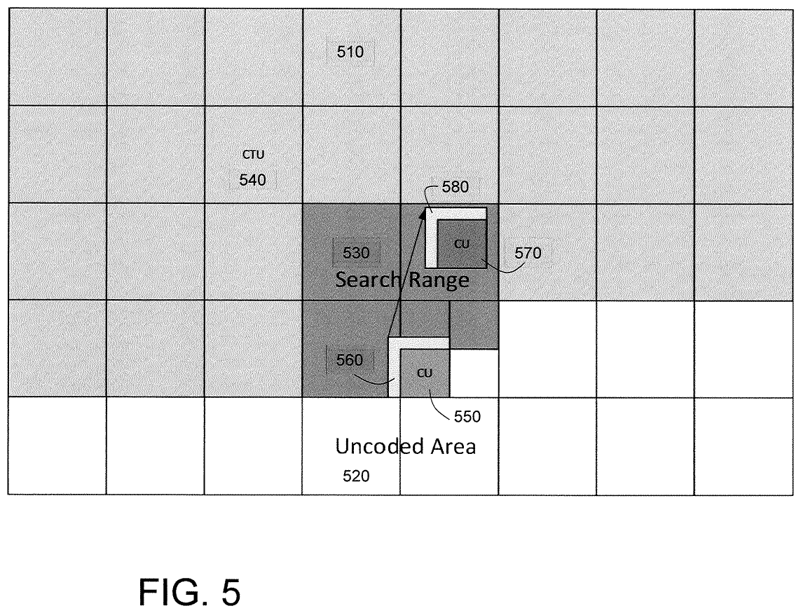

A special intra prediction mode introduced in ECM is intra template matching prediction (Intra TMP). In intra TMP, for a current CU (blue, 550), a template may be defined with the CU's left and above neighboring pixels (orange, 560), as shown in FIG. 5. For a current CU (blue, 550) in intra TMP mode, the encoder searches for the most similar template (orange, 580) to the CU's template (orange, 560) within a predefined search range (dark green, 530) inside the coded area (green, 510) of the current picture and uses the corresponding block (red, 570) as a prediction block. The coded area (green, 510), as well as the uncoded area (white, 520) may be made up of a plurality of CTUS (e.g. 540). Theoretically, the predefined search range (dark green, 530) can be anywhere inside the coded area of the current picture, but practically, it may be close to the current CU (blue, 550), as shown in FIG. 5. The encoder may then signal the usage of this intra TMP mode, and the decoder may perform the same prediction operation within the same predefined search range (e.g. dark green, 530). In the current ECM design, both the CU's template (orange, 560) and the associated search range for intra TMP (dark green, 530) comprise the reconstructed pixels before in-loop filtering, or the non-final reconstructed pixels, which may mean less accurate prediction.

In the present disclosure, the term “reference area” may be used for an area over which intra prediction is performed. For example, the “reference area” for IBC is an area over which a prediction block is searched for a current CU. In other words, the prediction block for a current CU is found in the reference area. The “search range” for intra TMP is an area over which a best template is searched for the template of a current CU. In other words, a best template for a current CU is found in the search range. Both “reference area” for IBC and “search area” for intra TMP may be considered as “reference area” for intra prediction in the present disclosure.

In an example embodiment, the final reconstructed pixels of the coded area of the current picture may be used for intra prediction. In an example embodiment, the coded area of the current picture after in-loop filtering may be used as the reference area for intra prediction. In an example embodiment, the reference area for intra prediction may comprise the final reconstructed pixels of the coded area of the current picture. In an example embodiment, the intra prediction block for a current CU may be constructed from the final reconstructed pixels of the current picture. A technical effect of example embodiments of the present disclosure may be to enable more accurate intra prediction.

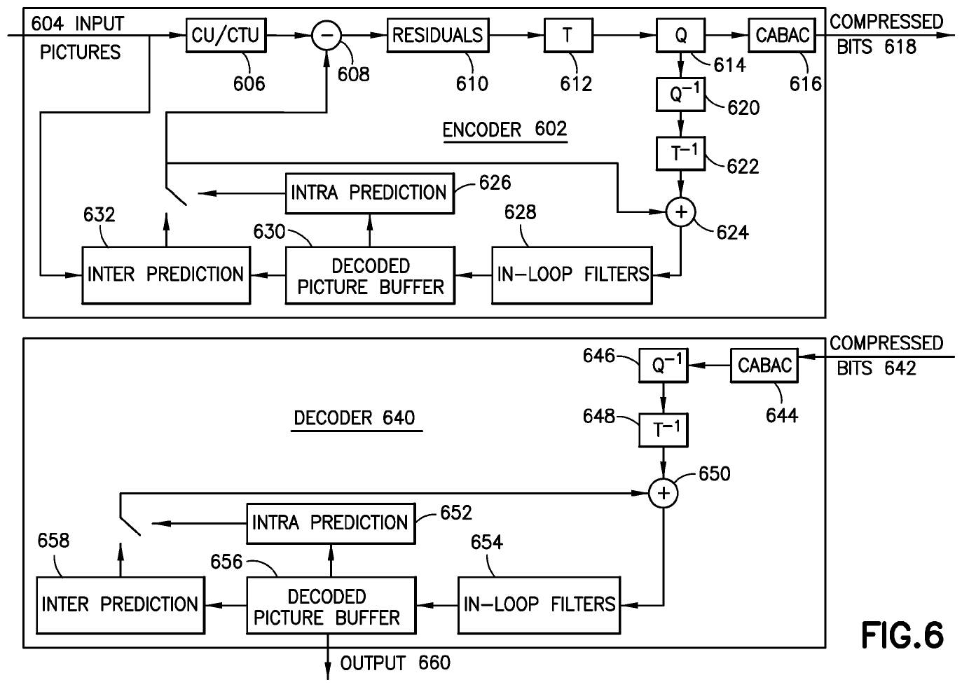

In an example embodiment, in both an encoder (602) and a decoder (640), in-loop filtering (628, 654) may be performed over the coded area of the current picture first, and then, the coded area after in-loop filtering are used as reference area for intra prediction (626, 652), as shown in FIG. 6. FIG. 6 illustrates an example in which intra prediction may be performed on the final reconstructed pixels of the current picture, rather than on reconstructed pixels of the current pixel that have not undergone in-loop filtering. In contrast to FIG. 3, FIG. 6 illustrates that intra prediction is performed on the output of in-loop filtering (628, 654), rather than on compressed bits (342) that have been decoded (344), dequantized (346), inverse transformed (348), and combined with the output of a prediction block (350). In an example embodiment, the reference area for intra prediction may comprise the final reconstructed pixels of the current picture. In an example embodiment, the intra prediction block for a current CU may be constructed from the final reconstructed pixels of the coded area of the current picture. A technical effect of example embodiments of the present disclosure may be to enable more accurate prediction.

It may be noted that features of FIG. 6 may be similar to those of FIG. 3; duplicative description is therefore not included here.

In an example, for IBC, the reference area for intra prediction for a current CU may be the coded area of the current picture after in-loop filtering. Hence, the intra prediction block for the current CU may be constructed from the final reconstructed pixels of the coded area of the current picture after in-loop filtering, not the non-final reconstructed pixels of the coded area of the current picture before in-loop filtering, as in the current design of WVC and ECM. In other words, in an example embodiment of the present disclosure, intra prediction may be performed based on different input.

In-loop filtering of a pixel in a reference area may use neighboring pixels (and/or other coding information). If some of those neighboring pixels have not yet been coded, they may not be available at the decoder. Hence, in-loop filtering for the pixel may not be able to be performed at the decoder (e.g. at a relevant time). Note that the encoder and the decoder may have to use the same reference picture(s) for inter prediction and the same reference area for intra prediction; otherwise, there may be a mismatch between encoder and decoder.

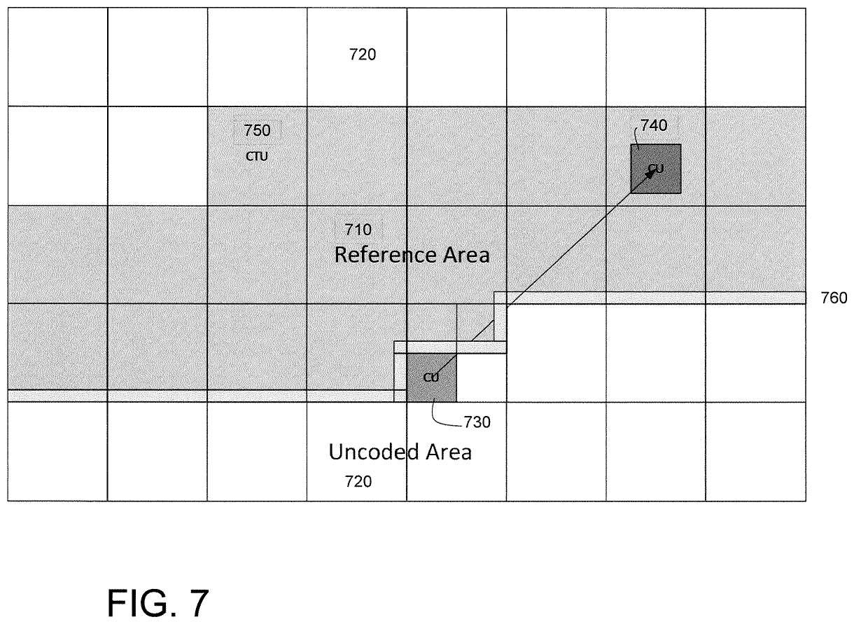

FIG. 7 shows an example for IBC, including a current CU (blue, 730), a prediction block (red, 740), the reference area for intra prediction for the current CU (green, 710), the uncoded area (white, 720), where image is made up of multiple CTU (e.g. 750). In-loop filtering may be performed for all the reconstructed pixels inside the reference area (green, 710), except those in the area (orange, 760) next to the uncoded area (white, 720). In-loop filtering of the orange-colored (760) pixels inside the reference area (green, 710) may require use of the reconstructed pixels (and/or other coding information) in the uncoded area (white, 720), which may not be available yet. Hence, in the example of FIG. 7, for the current CU (blue, 730), the orange-color pixels (760) inside the reference area (green, 710) may not already be in-loop filtered at the decoder, and therefore they may not be considered final reconstructed pixels at the decoder for intra-prediction.

With the current design(s) of in-loop filters in ECM, up to 8 pixels (e.g. orange, 760) inside the reference area (green, 710) away from the uncoded area (white, 720) may be affected, or not be in-loop filtered at a relevant time. In the present disclosure, these pixels may be referred to as “affected pixels.” Since the CTU size (e.g. 750) may often be set to 128×128 or even to 256×256, the area covered by the affected (i.e. non in-loop filtered) pixels (orange, 760) may be very small as compared to the entire reference area (green, 710). Hence, it may be expected that the impact of those affected pixels on overall coding performance may not be significant.

For each possible in-loop filter (deblocking, sample adaptive offset (SAO), adaptive loop filter (ALF), as well as enhanced features of bilateral filter (BIF), cross-component SAO (CCSAO), longer cross-component ALF (CCALF) and alternative band classifier for ALF (ABC-ALF)), there may be two possible options for handling the affected (i.e. non in-loop filtered) pixels (e.g. orange, 760). In an example embodiment, a first option may be to not perform the in-loop filter for the affected pixels. In other words, the affected pixels may be used as is. In another, alternative example embodiment, a second option may be to still perform the in-loop filter for the affected pixels, but with padding of the pixels in the uncoded area and setting of the coding information in the uncoded area to pre-determined value(s).

Note that the affected pixels may still be inside the reference area (e.g. green, 710) of the current picture at both encoder and decoder, and hence, they may still be used for intra prediction, even though they are not the final reconstructed pixels (e.g. FIG. 3). After the uncoded area (e.g. white, 720) is coded or becomes “available” at both encoder and decoder, in-loop filtering may be performed for the affected pixels, regardless of which of the above options (1 or 2) is used. For example, referring to FIG. 7, before a current CU (blue, 730) is coded, normal in-loop filtering may not be performed for its above and left neighboring pixels (orange, 760) because the current CU (blue, 730) has not been coded yet. Either option 1 or option 2 may be used to prepare those neighboring pixels (orange, 760) for intra prediction of the current CU (730). After the current CU (blue, 730) is coded, normal in-loop filtering may be performed for those affected above and left neighboring pixels (orange, 760) so that they can become the final reconstructed pixels.

In an example embodiment, in-loop filtering may be performed over the coded area of the current picture on a CU-by-CU basis, which may minimize the amount of affected pixels (e. g. orange, 760) inside the reference area (green, 710) for intra prediction. But, in the current design of VTM and ECM, the parameters of some in-loop filters (e. g. SAO and ALF) may be determined at the CTU level. Hence, practically, in-loop filtering may be performed over the coded area of the current picture on CTU-by-CTU basis.

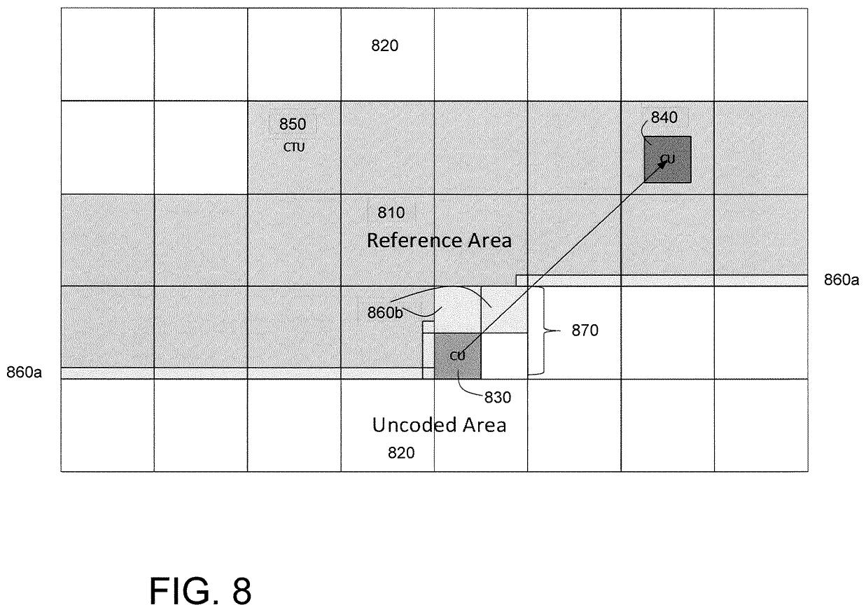

With in-loop filtering performed over the coded area of the current picture on a CTU-by-CTU basis, the affected pixels inside the reference area (green, 810) for intra prediction may also include the reconstructed pixels of the current CTU (870) containing the current CU (830), in addition to the reconstructed pixels (orange, 860a) next to the uncoded area (white, 820) of the current picture, as shown in FIG. 8 where the affected pixels (orange, 860) also include the reconstructed pixels in the current CTU (870) (i.e. orange, 860b). Even with the reconstructed pixels in the current CTU (orange, 860b), the affected pixels area (orange, 860a and 860b) inside the reference area (green) is still small as compared to the entire reference area. So, it may still be expected that the impact of the affected pixels (orange, 860a and 860b) on coding performance may not be significant.

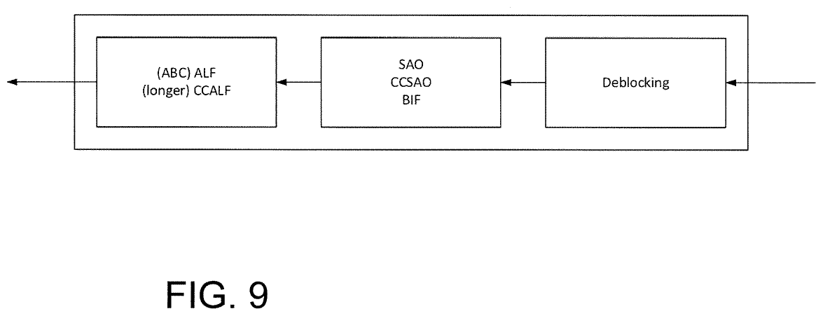

The basic in-loop filters in WVC comprise deblocking, SAO and ALF, and ECM further enhances in-loop filtering with additional features including BIF, CCSAO, longer CCALF, and ABC-ALF, as shown in FIG. 9. Additional and/or new in-loop filter features may be included in future video coding. For example, in-loop filters in future video coding may comprises neutral network based filtering.

A neural network is a computation graph consisting of two or more layers of computation. Each layer consists of one or more units, where each unit performs an elementary computation. A unit is connected to one or more other units, and the connection may have a weight associated with it. The weight may be used for scaling the signal passing through the associated connection. Weights may be learnable parameters, i.e., values which can be learned from training data. There may be other learnable parameters, such as those of batch-normalization layers.

Neural networks may be utilized in an ever increasing number of applications for many different types of device, such as mobile phones, as described above. Examples may include image and video analysis and processing, social media data analysis, device usage data analysis, etc.

Neural networks may be used for compressing and de-compressing data such as images. The most widely used architecture for compressing and de-compressing data is the auto-encoder, which may be a neural network consisting of two parts: a neural encoder and a neural decoder. In this description, a neural encoder may be referred to an encoder, and a neural decoder may be referred to as a decoder. An encoder and a decoder may comprise algorithms which are learned from data instead of being tuned by hand.

The encoder may take as input an image and produce a code which requires less bits than the input image. This code may be obtained by a binarization or quantization process after the encoder. The decoder may take this code and use it to reconstruct the image which was input to the encoder.

An encoder and decoder may be trained to minimize a coding cost based on bitrate and distortion, where the distortion is usually Mean Squared Error (MSE), etc. These distortion metrics are meant to be inversely proportional to the human visual perception quality. In other words, a lower measurement with a distortion metric corresponds to a better perceived quality of the decompressed image.

A video codec may consist of an encoder that transforms the input video into a compressed. suited for storage/transmission and a decoder that can decompress the compressed video representation back into a viewable form. An encoder may discard some information from the original video sequence in order to represent the video in a more compact form (i.e. at a lower bitrate). A decoder may reconstruct the output video from the compressed version of the video by applying prediction means similar to the encoder to form a predicted representation of the pixel blocks (e.g. using information created by the encoder and stored in the compressed representation) and prediction error decoding (inverse operation of the prediction error coding, e.g. comprising recovering the quantized prediction error signal in the spatial pixel domain). After applying prediction and prediction error decoding means, the decoder may sum up the prediction and prediction error signals (pixel values) to form the output video frame. The decoder (and encoder) may also apply additional filtering means to improve the quality of the output video before passing it for display and/or storing it as prediction reference for the forthcoming frames in the video sequence.

In an example embodiment, an encoder or decoder may use a neural network-based in-loop filter. For example, in FIG. 6, the in-loop filter (628, 654) may be neural networks based, and may learn to minimize coding costs while performing in-loop filtering and minimizing the error when reconstructing pixels.

In an example embodiment, only some, not all, of the in-loop filters (e.g. of FIG. 9) may be performed over the coded area of the current picture for intra prediction. The reference area for intra prediction may now comprise the semi-final reconstructed pixels of the coded area of the current picture. In other words, the reference area may comprise pixels that have only partially been in-loop filtered. The semi-final reconstructed pixels may still have the technical effect of providing relatively more accurate prediction than the non-final reconstructed pixels before in-loop filtering, as in the current design of VVC and ECM.

In an example embodiment, intra prediction may use the coded area of the current picture after only deblocking, SAO and ALF as reference area (see FIG. 9). In the examples of FIGS. 7 and 8, the reference area (green, 710, 810) may comprise the semi-final reconstructed pixels of the coded area of the current picture.

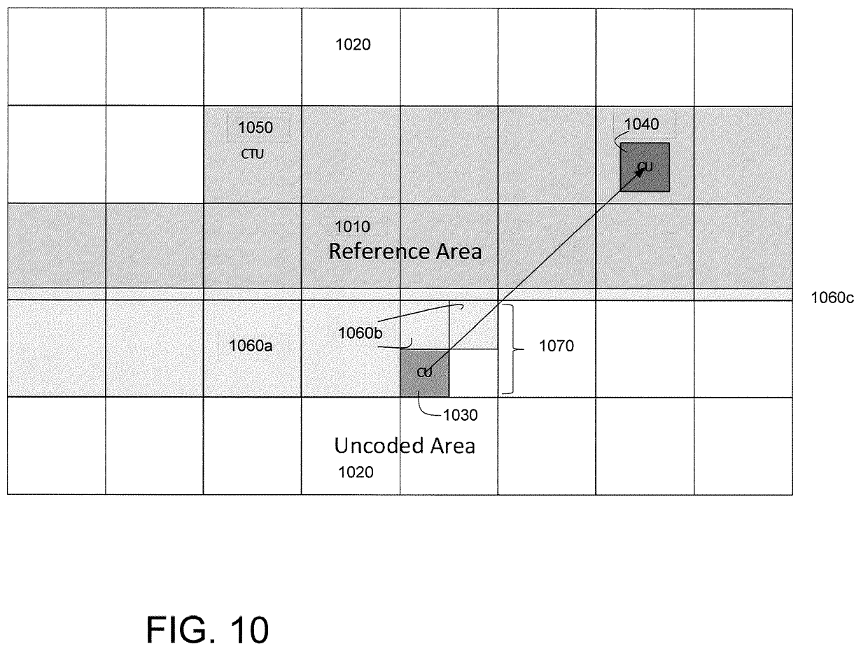

In another example embodiment, in-loop filtering may be performed over only a portion of the coded area of the current picture for intra prediction. The reference area for intra prediction may comprise two areas, one with the final reconstructed pixels and the other with the non-final reconstructed pixels. FIG. 10 shows an example, where in-loop filtering is only performed over the completed coded CTU rows of the coded area of the current picture. The reference area (green, 1010) above the current CTU (1070) comprises the final reconstructed pixels, and the reference area on the left of the current CTU comprises the non-final reconstructed pixels (orange, 1060a). Since there is a large portion of the reference area (green, 1010) with the final reconstructed pixels, better intra prediction may still expected as compared to the current design of VVC and ECM. be

FIG. 10 further illustrates an image divided into CTUs (e.g. 1050), part of which may be an uncoded area (white, 1020). The current CU (blue, 1030) may be associated with a prediction block (red, 1040), and affected pixels (orange, 1060a, 1060b, and 1060c).

In an alternative example embodiment, only some of the in-loop filters may be performed over only a portion of the coded area of the current picture. For example, the reference area for intra prediction may comprise one area the semi-final reconstructed pixels, and the other area with the non-final reconstructed pixels.

In all the above example embodiments, the encoder and the decoder shall follow the same rules for in-loop filtering of the reference area for intra prediction; otherwise, mismatch between encoder and decoder will occur.

A technical effect of example embodiments of the present disclosure may be to improve coding performance for any coding tools that use the coded area of the current picture for prediction, including but not limited to IBC and intra TMP.

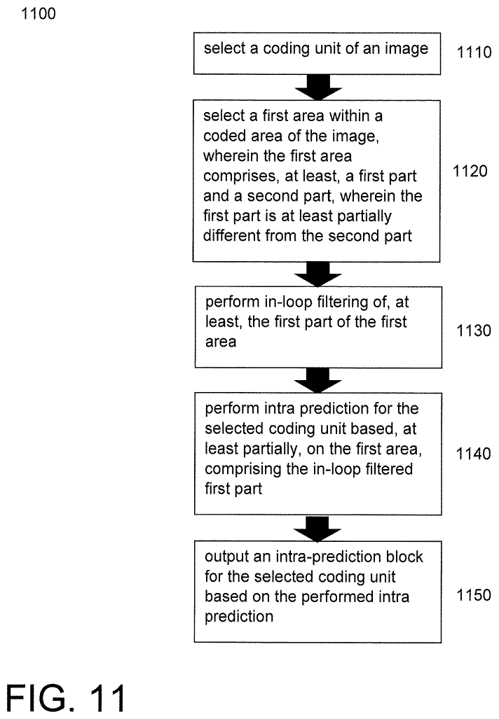

FIG. 11 illustrates the potential steps of an example method 1100. The example method 1100 may include: selecting a coding unit of an image, 1110; selecting a first area within a coded area of the image, wherein the first area comprises, at least, a first part and a second part, wherein the first part is at least partially different from the second part, 1120; performing in-loop filtering of, at least, the first part of the first area, 1130; performing intra prediction for the selected coding unit based, at least partially, on the first area, comprising the in-loop filtered first part, 1140; and outputting an intra-prediction block for the selected coding unit based on the performed intra prediction, 1150. In an example embodiment, the example method 1100 may be performed with a decoder. In an example embodiment, the example method 1100 may be performed with an encoder. In an example embodiment, the coded area of the image may comprise a reconstructed area(s)/block(s) of the image.

In accordance with one example embodiment, an apparatus may comprise: at least one processor; and at least one memory including computer program code; the at least one memory and the computer program code configured to, with the at least one processor, cause the apparatus at least to: select a coding unit of an image; select a first area within a coded area of the image, wherein the first area may comprise, at least, a first part and a second part, wherein the first part may be at least partially different from the second part; perform in-loop filtering of, at least, the first part of the first area; perform intra prediction for the selected coding unit based, at least partially, on the first area, comprising the in-loop filtered first part; and output an intra-prediction block for the selected coding unit based on the performed intra prediction.

The second part inside the first area within the coded area may not be in-loop filtered, wherein the intra prediction for the selected coding unit may be performed based on the first area, comprising the in-loop filtered first part and the second part that is not in-loop filtered.

The example apparatus may be further configured to: perform in-loop filtering of the second part inside the first area within the coded area based, at least partially, on at least one of: padding for pixels in an uncoded area of the image, or pre-determined coding values for the uncoded area of the image, wherein the intra prediction for the selected coding unit may be performed based on the first area, comprising the in-loop filtered first part and the in-loop filtered second part.

Performing the in-loop filtering may comprise the example apparatus being further configured to perform at least one of: a deblocking procedure, a sample adaptive offset procedure, an adaptive loop filter procedure, a cross-component sample adaptive offset procedure, a bilateral filter procedure, an alternative band classifier for adaptive loop filter procedure, a cross-component adaptive loop filter procedure, or a neural network-based filter procedure.

The image may comprise a current image, and wherein the current image may comprise the coded area and at least one uncoded area.

The coded area may comprise a plurality of pixels, and wherein the image may comprise part of a video.

The first area of the coded area of the image may comprise at least one of: a reference area of the image for intra block copy, wherein the intra block copy may comprise the example apparatus being configured to determine a first prediction block in the reference area for the selected coding unit, or a search area of the image for intra template matching prediction, wherein the intra template matching prediction may comprise the example apparatus being configured to determine a template within the search area of the selected coding unit, and determine a second prediction block, in the search area, for the selected coding unit based, at least partially, on the defined template.

The example apparatus may comprise a decoder of the image.

The example apparatus may comprise an encoder of the image.

In accordance with one aspect, an example method may be provided comprising: selecting a coding unit of an image; selecting a first area within a coded area of the image, wherein the first area may comprise, at least, a first part and a second part, wherein the first part may be at least partially different from the second part; performing in-loop filtering of, at least, a first part of the first area; performing intra prediction for the selected coding unit based, at least partially, on the first area, comprising the in-loop filtered first part; and outputting an intra-prediction block for the selected coding unit based on the performed intra prediction.

The second part inside the first area within the coded area may not be in-loop filtered, wherein the intra prediction for the selected coding unit may be performed based on the first area, comprising the in-loop filtered first part and the second part that is not in-loop filtered.

The example method may further comprise: performing in-loop filtering of the second part inside the first area within the coded area based, at least partially, on at least one of: padding for pixels in an uncoded area of the image, or pre-determined coding values for the uncoded area of the image, wherein the intra prediction for the selected coding unit may be performed based on the first area, comprising the in-loop filtered first part and the in-loop filtered second part.

The performing of the in-loop filtering may comprise performing at least one of: a deblocking procedure, a sample adaptive offset procedure, an adaptive loop filter procedure, a cross-component sample adaptive offset procedure, a bilateral filter procedure, an alternative band classifier for adaptive loop filter procedure, a cross-component adaptive loop filter procedure, or a neural network-based filter procedure.

The image may comprise a current image, and wherein the current image may comprise the coded area and at least one uncoded area.

The coded area may comprise a plurality of pixels, and wherein the image may comprise part of a video.

The first area of the coded area of the image may comprise at least one of: a reference area of the image for intra block copy, wherein the intra block copy may comprise determining a first prediction block in the reference area for the selected coding unit, or a search area of the image for intra template matching prediction, wherein the intra template matching prediction may comprise determining a template within the search area of the selected coding unit, and determining a second prediction block, in the search area, for the selected coding unit based, at least partially, on the defined template.

The example method may be performed by an encoder of the image.

The example method may be performed by a decoder of the image.

In accordance with one example embodiment, an apparatus may comprise: circuitry configured to perform: select a coding unit of an image; select a first area within a coded area of the image, wherein the first area may comprise, at least, a first part and a second part, wherein the first part may be at least partially different from the second part; perform in-loop filtering of, at least, the first part of the first area; perform intra prediction for the selected coding unit based, at least partially, on the first area, comprising the in-loop filtered first part; and output an intra-prediction block for the selected coding unit based on the performed intra prediction.

In accordance with one example embodiment, an apparatus may comprise: processing circuitry; memory circuitry including computer program code, the memory circuitry and the computer program code configured to, with the processing circuitry, enable the apparatus to: select a coding unit of an image; select a first area within a coded area of the image, wherein the first area may comprise, at least, a first part and a second part, wherein the first part may be at least partially different from the second part; perform in-loop filtering of, at least, the first part of the first area; perform intra prediction for the selected coding unit based, at least partially, on the first area, comprising the in-loop filtered first part; and output an intra-prediction block for the selected coding unit based on the performed intra prediction.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: selecting a coding unit of the image; selecting a first area within a coded area of the image, wherein the first area may comprise, at least, a first part and a second part, wherein the first part may be at least partially different from the second part; in-loop filtering of, at least, the first part of the first area; intra prediction for the selected coding unit based, at least partially, on the first area, comprising the in-loop filtered first part; and outputting an intra-prediction block for the selected coding unit based on the performed intra prediction.

The second part inside the first area within the coded area may not be in-loop filtered, wherein the intra prediction for the selected coding unit may be performed based on the first area, comprising the in-loop filtered first part and the second part that is not in-loop filtered.

The means may be further configured to perform: in-loop filtering of the second part inside the first area within the coded area based, at least partially, on at least one of: padding for pixels in an uncoded area of the image, or pre-determined coding values for the uncoded area of the image, wherein the intra prediction for the selected coding unit may be performed based on the first area, comprising the in-loop filtered first part and the in-loop filtered second part.

The means configured to perform the in-loop filtering may comprise means configured to perform at least one of: a deblocking procedure, a sample adaptive offset procedure, an adaptive loop filter procedure, a cross-component sample adaptive offset procedure, a bilateral filter procedure, an alternative band classifier for adaptive loop filter procedure, a cross-component adaptive loop filter procedure, or a neural network-based filter procedure.

The image may comprise a current image, and wherein the current image may comprise the coded area and at least one uncoded area.

The coded area may comprise a plurality of pixels, and wherein the image may comprise part of a video.

The first area of the coded area of the image may comprise at least one of: a reference area of the image for intra block copy, wherein the intra block copy may comprise determining a first prediction block in the reference area for the selected coding unit, or a search area of the image for intra template matching prediction, wherein the intra template matching prediction may comprise determining a template within the search area of the selected coding unit, and determining a second prediction block, in the search area, for the selected coding unit based, at least partially, on the defined template.

The example apparatus may comprise a decoder of the image.

The example apparatus may comprise an encoder of the image.

In accordance with one example embodiment, a non-transitory computer-readable comprising program medium instructions stored thereon which, when executed with at least one processor, cause the at least one processor to: select a coding unit of the image; select a first area within a coded area of the image, wherein the first area may comprise, at least, a first part and a second part, wherein the first part may be at least partially different from the second part; perform in-loop filtering of, at least, the first part of the first area; perform intra prediction for the selected coding unit based, at least partially, on the first area, comprising the in-loop filtered first part; and cause output of an intra-prediction block for the selected coding unit based on the performed intra prediction.

The second part inside the first area within the coded area may not be in-loop filtered, wherein the intra prediction for the selected coding unit may be performed based on the first area, comprising the in-loop filtered first part and the second part that is not in-loop filtered.

The example non-transitory computer-readable medium may be further configured to: perform in-loop filtering of the second part inside the first area within the coded area based, at least partially, on at least one of: padding for pixels in an uncoded area of the image, or pre-determined coding values for the uncoded area of the image, wherein the intra prediction for the selected coding unit may be performed based on the first area, comprising the in-loop filtered first part and the in-loop filtered second part.

Performing the in-loop filtering may comprise the example non-transitory computer-readable medium being further configured to perform at least one of: a deblocking procedure, a sample adaptive offset procedure, an adaptive loop filter procedure, a cross-component sample adaptive offset procedure, a bilateral filter procedure, an alternative band classifier for adaptive loop filter procedure, a cross-component adaptive loop filter procedure, or a neural network-based filter procedure.

The image may comprise a current image, and wherein the current image may comprise the coded area and at least one uncoded area.

The coded area may comprise a plurality of pixels, wherein the image may comprise part of a video.

The area of the coded area of the image may comprise at least one of: a reference area of the image for intra block copy, wherein the intra block copy may comprise causing determining a first prediction block in the reference area for the selected coding unit, or a search area of the image for intra template matching prediction, the intra wherein template matching prediction may comprise causing determining a template within the search area of the selected coding unit, and causing determining a second prediction block, in the search area, for the selected coding unit based, at least partially, on the defined template.

The example non-transitory computer-readable medium may be comprised by a decoder of the image.

The example non-transitory computer-readable medium may be comprised by an encoder of the image.

In accordance with another example embodiment, a non-transitory program storage device readable by a machine may be provided, tangibly embodying a program of instructions executable by the machine for performing operations, the operations comprising: select a coding unit of the image; select a first area within a coded area of the image, wherein the first area may comprise, at least, a first part and a second part, wherein the first part may be at least partially different from the second part; perform in-loop filtering of, at least, the first part of the first area; perform intra prediction for the selected coding unit based, at least partially, on the first area, comprising the in-loop filtered first part; and cause output of an intra-prediction block unit based on the performed intra prediction.

It should be understood that the foregoing description is only illustrative. Various alternatives and modifications can be devised by those skilled in the art. For example, features recited in the various dependent claims could be combined with each other in any suitable combination(s). In addition, features from different described embodiments above could be selectively combined into a new embodiment. Accordingly, the description is intended to embrace all such alternatives, modification and variances which fall within the scope of the appended claims.

1-32. (canceled)

33. An apparatus comprising:
at least one processor; and
at least one memory storing instructions that, when executed by the at least one processor, cause the apparatus at least to:
select a coding unit of an image;
select a first area within a coded area of the image, wherein the first area comprises, at least, a first part and a second part, wherein the first part is at least partially different from the second part;
perform in-loop filtering of, at least, the first part of the first area;
perform intra prediction for the selected coding unit based, at least partially, on the first area, comprising the in-loop filtered first part; and
output an intra-prediction block for the selected coding unit based on the performed intra prediction.

34. The apparatus of claim 33, wherein the second part is not in-loop filtered, and wherein the intra prediction for the selected coding unit is performed further based on the second part that is not in-loop filtered.

35. The apparatus of claim 33, wherein the apparatus is further caused to:
perform in-loop filtering of the second part based, at least partially, on at least one of:
padding for pixels in an uncoded area of the image; or
pre-determined coding values for the uncoded area of the image;
wherein the intra prediction for the selected coding unit is performed based on the first area, comprising the in-loop filtered first part and the in-loop filtered second part.

36. The apparatus of claim 33, wherein to perform the in-loop filtering, the apparatus is further caused to perform at least one of:
a deblocking procedure;
a sample adaptive offset procedure;
an adaptive loop filter procedure;
a cross-component sample adaptive offset procedure;
a bilateral filter procedure;
an alternative band classifier for the adaptive loop filter procedure;
a cross-component adaptive loop filter procedure; or
a neural network-based filter procedure.

37. The apparatus of claim 33, wherein the image comprises a current image, and wherein the current image comprises the coded area and at least one uncoded area.

38. The apparatus of claim 33, wherein the coded area comprises a plurality of pixels, and wherein the image comprises part of a video.

39. The apparatus of claim 33, wherein the first area of the coded area of the image comprises at least one of:
a reference area of the image for intra block copy, wherein the intra block copy comprises, and wherein the apparatus is further caused to determine a first prediction block in the reference area for the selected coding unit; or
a search area of the image for intra template matching prediction, wherein the intra template matching prediction, and wherein the apparatus is further caused to determine a template within the search area of the selected coding unit, and determine a second prediction block, in the search area, for the selected coding unit based, at least partially, on a defined template.

40. The apparatus of claim 33, wherein the apparatus comprises a decoder of the image.

41. The apparatus of claim 33, wherein the apparatus comprises an encoder of the image.

42. A method comprising:
selecting a coding unit of an image;
selecting a first area within a coded area of the image, wherein the first area comprises, at least, a first part and a second part, wherein the first part is at least partially different from the second part;
performing in-loop filtering of, at least, the first part of the first area;
performing intra prediction for the selected coding unit based, at least partially, on the first area, comprising the in-loop filtered first part; and
outputting an intra-prediction block for the selected coding unit based on the performed intra prediction.

43. The method of claim 42, wherein the second part is not in-loop filtered, and wherein the intra prediction for the selected coding unit is performed further based on the second part that is not in-loop filtered.

44. The method of claim 42, further comprising:
performing in-loop filtering of the second part based, at least partially, on at least one of:
padding for pixels in an uncoded area of the image; or
pre-determined coding values for the uncoded area of the image;
wherein the intra prediction for the selected coding unit is performed based on the first area, comprising the in-loop filtered first part and the in-loop filtered second part.

45. The method of claim 42, wherein performing the in-loop filtering comprises performing at least one of:
a deblocking procedure;
a sample adaptive offset procedure;
an adaptive loop filter procedure;
a cross-component sample adaptive offset procedure;
a bilateral filter procedure;
an alternative band classifier for the adaptive loop filter procedure;
a cross-component adaptive loop filter procedure; or
a neural network-based filter procedure.

46. The method of claim 42, wherein the image comprises a current image, and wherein the current image comprises the coded area and at least one uncoded area.

47. The method of claim 42, wherein the coded area comprises a plurality of pixels, and wherein the image comprises part of a video.

48. The method of claim 42, wherein the first area of the coded area of the image comprises at least one of:
a reference area of the image for intra block copy, wherein the intra block copy comprises determining a first prediction block in the reference area for the selected coding unit; or
a search area of the image for intra template matching prediction, wherein the intra template matching prediction comprises determining a template within the search area of the selected coding unit, and determining a second prediction block, in the search area, for the selected coding unit based, at least partially, on a defined template.

49. A computer-readable medium comprising program instructions stored thereon which, when executed with at least one processor, cause the at least one processor to:
select a coding unit of an image;
select a first area within a coded area of the image, wherein the first area comprises, at least, a first part and a second part, wherein the first part is at least partially different from the second part;
perform in-loop filtering of, at least, the first part of the first area;
perform intra prediction for the selected coding unit based, at least partially, on the first area, comprising the in-loop filtered first part; and
cause output of an intra-prediction block for the selected coding unit based on the performed intra prediction.

50. The computer-readable medium of claim 49, wherein the second part is not in-loop filtered, and wherein the intra prediction for the selected coding unit is performed further based on the second part that is not in-loop filtered.

51. The computer-readable medium of claim 49, further comprising program instructions stored thereon which, when executed with the at least one processor, cause the at least one processor to:
perform in-loop filtering of the second part based, at least partially, on at least one of:
padding for pixels in an uncoded area of the image; or
pre-determined coding values for the uncoded area of the image;
wherein the intra prediction for the selected coding unit is performed based on the first area, comprising the in-loop filtered first part and the in-loop filtered second part.

52. The computer-readable medium of claim 49, wherein performing the in-loop filtering comprises the program instructions, when executed with the at least one processor, further cause the at least one processor to perform at least one of:
a deblocking procedure;
a sample adaptive offset procedure;
an adaptive loop filter procedure;
a cross-component sample adaptive offset procedure;
a bilateral filter procedure;
an alternative band classifier for the adaptive loop filter procedure;
a cross-component adaptive loop filter procedure; or
a neural network-based filter procedure.
